(19) United States
(12) Patent Application Publication
(10) Pub. No.: US 2007/0047860 A1
(43) Pub. Date: Mar. 1, 2007

(54) Bearing device capable of correcting misalignment automatically

(76) Inventor: Jun-Chien Yen, Taipei (TW)

Correspondence Address: G. LINK Co., LTD, 3550 Bell Road, MINOOKA, IL, 60447, US

(21) Appl. No.: 11/213,693

(22) Filed: Aug. 30, 2005

(51) Int. Cl. F16C 25/00

(52) U.S. Cl. 384/267

(57) ABSTRACT

A bearing device capable of correcting deviation automatically includes a bearing, a spindle, an axial barrel, a driving part and an elastic member. The bearing is composed of at least a cone shaped shell member, which defines an orifice. The spindle fits with the bearing via the orifice. The axial barrel provides an inner conical wall corresponding to and fitting with the bearing. The driving part is disposed at a side of the bearing. The elastic member is disposed at a side of the driving part with elastic force thereof urging the driving part to move forward. When a clearance is formed between the bearing and the spindle due to accumulated wear-out occurred via a long period of running, the elastic member presses the driving part to move bearing toward a preset space in the axial barrel such that the orifice is reduced to maintain a tight fit between the spindle and the bearing.

### BACKGROUND OF THE INVENTION

1. Field of the Invention

The present invention is related to a bearing device capable of correcting misalignment automatically and particularly to a bearing device, which is able to correct misalignment resulting from abrasive wear due to a long period of running.

2. Brief Description of the Related Art

Because computer information industry progresses rapidly, it brings to much higher operation speed of the central processing unit (CPU) in an information product along with much more heat generated by the CPU. In order to remove heat effectively, the heat dissipation device such as a fan is the essential device for removing heat. It is known that the fan is conveniently mounted to the CPU and price thereof is much cheaper. Quality of a cooling fan depends on running condition of a motor thereof and unstable running of the motor affects normal operation of the entire system of the information product. Further, motor bearings being mounted to the motor is a key influencing quality of the motor and work stability.

Generally, when the shaft of a motor rotates, friction is generated between the shaft and the bearings and the inner bores of the bearings are getting larger after a long period of abrasive wear. Finally, it results in the shaft oscillating and noise to affect running performance of the motor. Deficiencies such as vibration, heat generation and useless power consumption of the motor bearings are worth us to care and overcome.

### SUMMARY OF THE INVENTION

In order to solve the preceding problems, an object of the present invention is to provide a bearing device capable of correcting misalignment automatically in which the bearing fits with an axial barrel and misalignment of the bearing can be corrected automatically to keep tight fit with shaft for avoiding oscillation of the bearing.

Another object of the present invention is to provide a bearing device capable of correcting misalignment automatically such that stable running of the shaft can be maintained to avoid noise, heat generation and useless power consumption for enhancing efficiency.

A further object of the present invention is to provide a bearing device capable of correcting misalignment automatically for avoiding worse abrasive wear to the bearing and the shaft.

Accordingly, a bearing device capable of correcting deviation automatically includes a bearing, a spindle, an axial barrel, a driving part and an elastic member. The bearing is composed of at least a cone shaped shell member, which defines an orifice. The spindle fits with the bearing via the orifice. The axial barrel provides an inner conical wall corresponding to and fitting with the bearing. The driving part is disposed at a side of the bearing. The elastic member is disposed at a side of the driving part with elastic force thereof urging the driving part to move forward. When a clearance is formed between the bearing and the spindle due to accumulated wear-out occurred via a long period of running, the elastic member presses the driving part to move bearing toward a preset space in the axial barrel such that the orifice is reduced to maintain a tight fit between the spindle and the bearing.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a sectional view of the first embodiment of a bearing device capable of correcting deviation automatically according to the present invention;

FIG. 2 is an exploded perspective view of the first embodiment of a bearing device capable of correcting deviation automatically according the present invention shown in FIG. 1;

FIG. 3 is a sectional view of the second embodiment of a bearing device capable of correcting deviation automatically according to the present invention;

FIG. 4 is an exploded perspective view of the second embodiment of a bearing device capable of correcting deviation automatically according the present invention shown in FIG. 3;

FIG. 5 is a sectional view of the third embodiment of a bearing device capable of correcting deviation automatically according to the present invention; and

FIG. 6 is an exploded perspective view of the third embodiment of a bearing device capable of correcting deviation automatically according the present invention shown in FIG. 5.

### DETAILED DESCRIPTION OF THE INVENTION

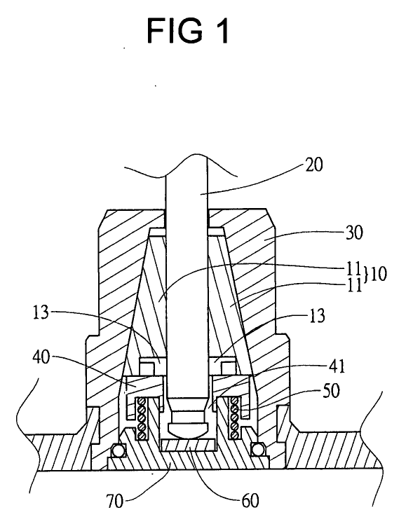

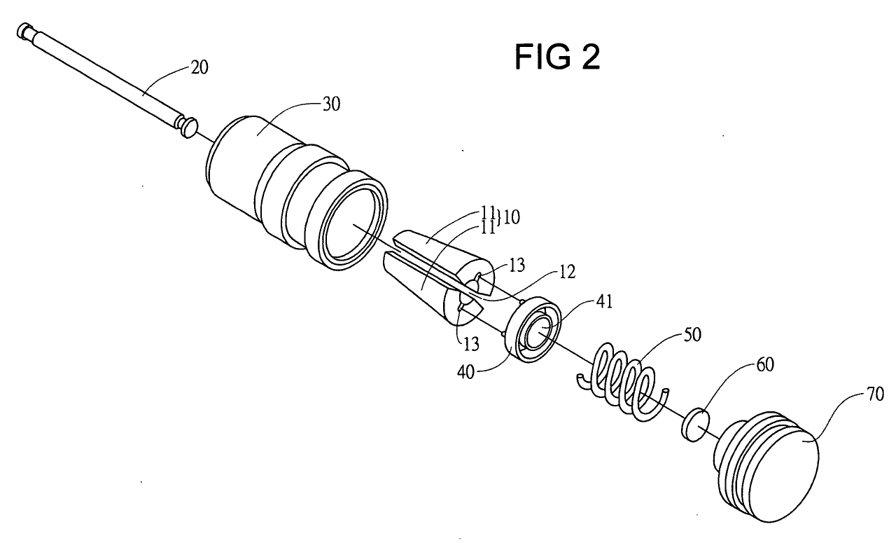

Referring to FIGS. 1 and 2, the first preferred embodiment of a bearing device capable of correcting deviation automatically according to the present invention includes a bearing 10, a spindle 20, an axial barrel 30, a driving part 40, an elastic member 50, a washer 60 and a bearing seat 70.

The bearing 10 is composed of a plurality of shell members 11 and defines an orifice 12 for fitting with the spindle 20. The bearing 10 provides a shape of cone, that is, the shell members 11 converge axially from an end to another end and enclose the periphery of the spindle 20. Besides, the bearing 10 at least has a locating recess 13 at one of the two ends for being attached with the driving part 40.

The elastic member 50 is disposed at a side of the driving part 40 for urging or moving the drive part 40 such that the bearing 10 is able to displace forward. The axial barrel 30 has an inner conical wall corresponding to the bearing 10 so that the bearing 10 is able to fit with the axial barrel 30. When a clearance is formed between the bearing 10 and the spindle 20 after a long period of running, the elastic member 50 allows the driving part 40 pushing the shell members 11 toward a preset space at the inner wall of the axial barrel 30 to reduce the orifice 12 such that a tight fit between the spindle 20 and the bearing 10 can be maintained to avoid oscillation the bearing 10 and the running performance can be promoted.

The elastic member 50 shown in FIG. 2 is a spring and the driving part 40 has a through hole 41 for being passed by the spindle 20 with the spring being supported with the bearing seat 70. The washer 60 is disposed between the spindle 20 and the bearing seat 70 to decrease friction and vibration between the spindle 20 and the bearing seat 70. Alternatively, the spindle 20 can be arranged not to touch the bearing seat 70 or without the bearing seat 70.

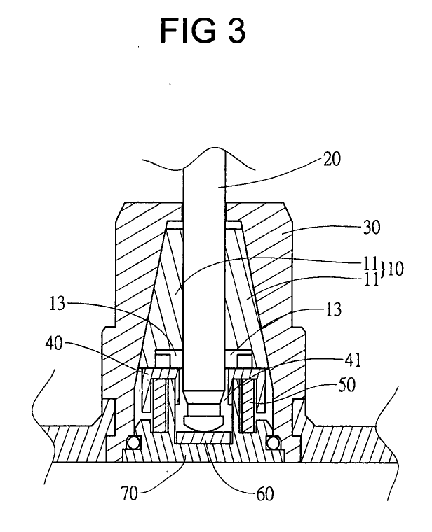

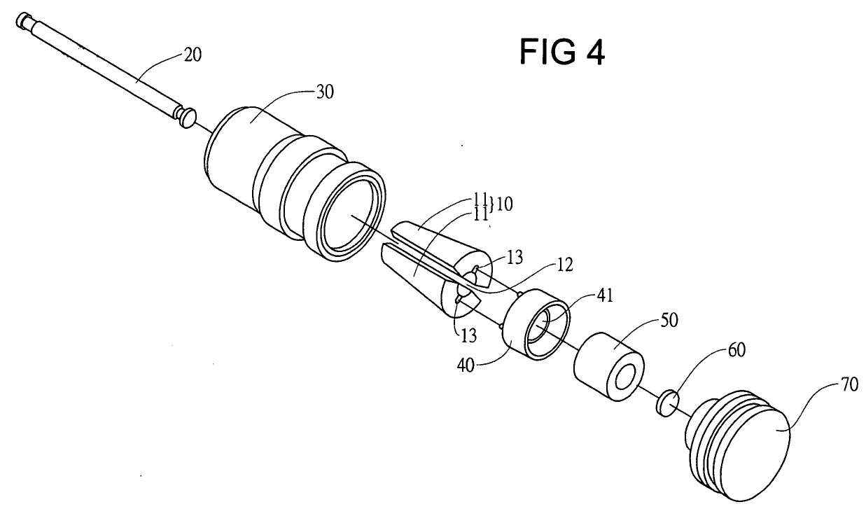

Referring to FIGS. 3 and 4, the elastic member 50 can be an elastic cylindrical member, which is able to provide a function of the original spring.

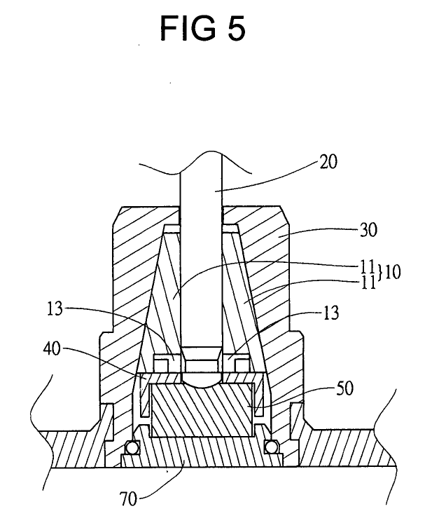

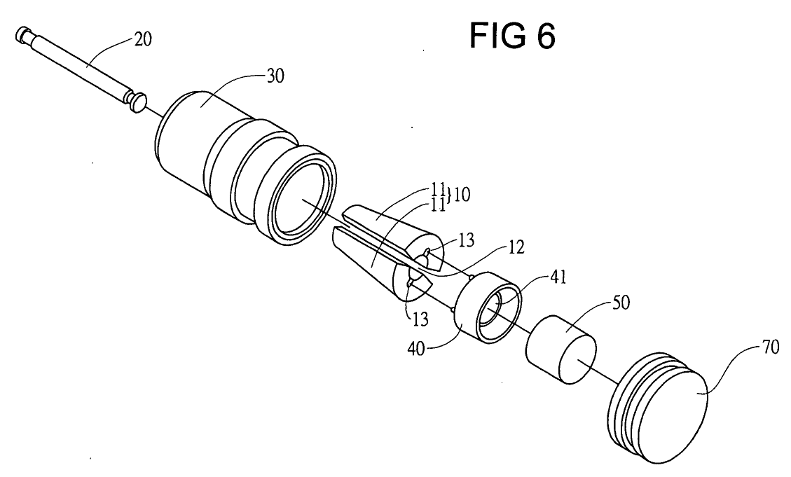

Referring to FIGS. 5 and 6, the elastic member 50 can be an elastic solid cylindrical member 50, which is able to provide a function of the original spring and the washer 60.

While the invention has been described with referencing to preferred embodiments thereof, it is to be understood that modifications or variations may be easily made without departing from the spirit of this invention, which is defined by the appended claims.

What is claimed is:

1. A bearing device capable of correcting deviation automatically, comprising:
a bearing, being composed of at least a cone shaped shell member, which defines an orifice;
a spindle, fitting with the bearing via the orifice;
an axial barrel, providing an inner conical wall corresponding to and fitting with the bearing;
a driving part, being disposed at a side of the bearing;
an elastic member, being disposed at a side of the driving part with elastic force thereof urging the driving part to move forward;
whereby, when a clearance is formed between the bearing and the spindle due to accumulated wear-out occurred via a long period of running, the elastic member presses the driving part to move bearing toward a preset space in the axial barrel such that the orifice is reduced to maintain a tight fit between the spindle and the bearing.

2. The bearing device capable of correcting deviation automatically as defined in claim 1, wherein the bearing provides at least a locating recess at an end thereof for being joined to the driving part.

3. The bearing device capable of correcting deviation automatically as defined in claim 1, wherein the elastic member is a spring.

4. The bearing device capable of correcting deviation automatically as defined in claim 1, wherein the driving part has a through hole.

5. The bearing device capable of correcting deviation automatically as defined in claim 1, wherein the axial seat provides a bearing seat.

6. The bearing device capable of correcting deviation automatically as defined in claim 5, wherein the bearing seat has a washer.

7. The bearing device capable of correcting deviation automatically as defined in claim 1, wherein the elastic member is an elastic cylindrical member.
